(19) United States
(12) Patent Application Publication
(10) Pub. No.: US 2005/0073781 A1
(43) Pub. Date: Apr. 7, 2005

(54) Electrostatic discharge protection conductor

(76) Inventors: Chin-Lung Hsu, Sijhih City (TW); Ren-Jun Cao, Suzhou (CN)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/959,411

(22) Filed: Oct. 6, 2004

(30) Foreign Application Priority Data
Oct. 6, 2003 (TW) 92127722

(51) Int. Cl. H02H 9/00

(52) U.S. Cl. 361/56

(57) ABSTRACT

An electrostatic discharge protection conductor disposed on a printed circuit board and electrically connected to a ground circuit is provided. The electrostatic discharge protection conductor includes a body portion and at least a protruding portion. The body portion has a solder's bottom surface and a lateral surface. The solder's bottom surface is soldered on the surface of the printed circuit board. The protruding portion which is disposed on the lateral surface of the body portion is electrically connected to the body portion. The protruding portion has an acute angle end whose bottom surface has an altitude difference with the solder's bottom surface.

This application claims the benefit of Taiwan application Serial No. 92127722, filed Oct. 6, 2003, the subject matter of which is incorporated herein by reference.

### BACKGROUND OF THE INVENTION

1. Field of the Invention

The invention relates in general to an electrostatic discharge (ESD) protection conductor, and more particularly to an electrostatic discharge protection conductor using an acute end structure to introduce electrostatic charges from outside and further have the introduced electrostatic charges delivered to a printed circuit board.

2. Description of the Related Art

With the rapid advance in science and technology, electronic devices have become indispensable to modern people's everyday life. Portable electronic devices featured by the characteristics of slimness, compactness and portability have won great popularity, particularly portable electronic devices such as notebook, personal digital assistant (PDA) and mobile phone.

Generally speaking, an electronic device includes at least a casing, a printed circuit board and plural electronic elements, wherein the printed circuit board and the electronic elements disposed thereon are disposed within the casing.

When an electronic device is stricken by external static electricity, the invading static electricity will deposit at electronic elements within the electronic device. This will cause breakdown to these electronic elements and shorten their lifespan, affecting the reliability of the electronic device greatly. In response to the current trend that electronic devices are facing, i.e., reduction in volume and diversity in function, electronic elements will accordingly reduce their volumes but increase their static electricity sensitivity. Therefore how to enhance the electrostatic discharge protection of an electronic device has come to the fore and become an imminent challenge.

### SUMMARY OF THE INVENTION

It is therefore an object of the invention to provide an electrostatic discharge (ESD) protection conductor which introduces internal electrostatic charges to an electronic device and further has the introduced electrostatic charges delivered to a ground circuit on a printed circuit board or to other ground conducting wires within the electronic device so as to enhance the electrostatic discharge protection of the electronic device.

It is another object of the invention to provide an electrostatic discharge protection conductor disposed on the surface of a printed circuit board and electrically connected to a ground circuit of the printed circuit board. The electrostatic discharge protection conductor includes a body portion and at least a protruding portion. The body portion has a solder's bottom surface and a lateral surface. The solder's bottom surface is soldered on the surface of the printed circuit board. The protruding portion, which is electrically connected to the body portion, is disposed on the lateral surface of the body portion. The protruding portion has an acute angle end whose bottom surface has an altitude difference with the solder's bottom surface.

It is another object of the invention to provide an electrostatic device including a printed circuit board and an electrostatic discharge protection conductor. The electrostatic discharge protection conductor is disposed on the surface of a printed circuit board and is electrically connected to a ground circuit thereon. The electrostatic charge protection conductor includes a body portion and at least a protruding portion. The body portion has a solder's bottom surface and a lateral surface. The solder's bottom surface is soldered on the surface of the printed circuit board. The protruding portion, which is electrically connected to the body portion, is disposed on the lateral surface of the body portion. The protruding portion has an acute angle end whose bottom surface has an altitude difference with the solder's bottom surface.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a three-dimensional diagram of an electrostatic charge protection conductor according to the preferred embodiment of the invention;

FIG. 2 is a sectional view along the x-axis of the electrostatic charge protection conductor in FIG. 1;

FIG. 3 is a top view along the z-axis of the electrostatic charge protection conductor in FIG. 1;

FIG. 4 is a cross-sectional view showing the status when the electrostatic charge protection conductor in FIG. 2 is soldered on a printed circuit board within an electronic device; and

FIG. 5 is a cross-sectional view showing the status when the electrostatic charge protection conductor in FIG. 2 is formed by using a press head and a press platform.

### DETAILED DESCRIPTION OF THE INVENTION

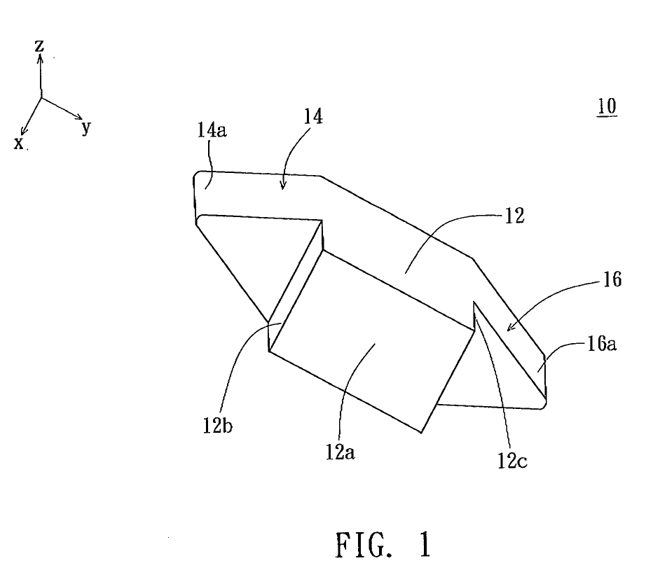

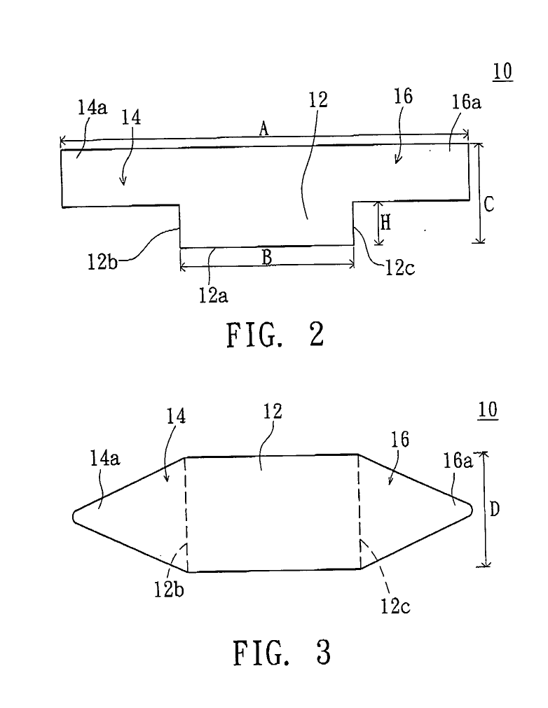

Referring to FIG. 1 to FIG. 3 at the same time. FIG. 1 is a three-dimensional diagram of an electrostatic charge protection conductor according to the preferred embodiment of the invention; FIG. 2 is a sectional view along the x-axis of the electrostatic charge protection conductor in FIG. 1; FIG. 3 is a top view along the z-axis of the electrostatic charge protection conductor in FIG. 1. From FIG. 1 to FIG. 3, electrostatic charge protection conductor 10 includes a body portion 12 and at least a protruding portion. The present preferred embodiment of the invention uses a first protruding portion 14 and a second protruding portion 16 to exemplify the protruding portion. The body portion 12 has a solder's bottom surface 12a, a first lateral surface 12b and a second lateral surface 12c, wherein the solder's bottom surface 12a connects two opposing surfaces, i.e., the first lateral surface 12b and the second lateral surface 12c.

The first protruding portion 14 and the second protruding portion 16, which are electrically connected to the body portion 12, are respectively disposed on the first lateral surface 12b and the second lateral surface 12c and are respectively equipped with a first acute angle end 14a and a second acute angle end 16a. The three top surfaces, namely, the top surface of the body portion 12, the top surface of the first protruding portion 14 and the top surface of the second protruding portion 16, are coplanar. The bottom surface of the first acute angle end 14a and that of the second acute angle end 16a respective has a first and a second altitude difference with the solder's bottom surface 12a.

In the present preferred embodiment of the invention, the first altitude difference may equal to the second altitude difference and both are equal to H, which measures 0.20 mm for instance, as shown in FIG. 2. In FIG. 2, the distance between the first acute angle end 14a and the second acute angle end 16a is A, which measures 2.19 mm for instance. The length of the solder's bottom surface 12a of the body portion 12 is B, which measures 1.00 mm for instance. The thickness of the body portion 12 is C, which measures 0.50 mm for instance. In FIG. 3, the width of the top surface of the body portion, D, which measures 0.80 mm for instance, is equal to the width of the solder's bottom surface 12a of the body portion 12 in FIG. 1. It is noteworthy that the configuration of the sharp end of the first acute angle end 14a and that of the second acute angle end 16a may have a curvature, say, an arc curvature whose radius is 0.10 mm.

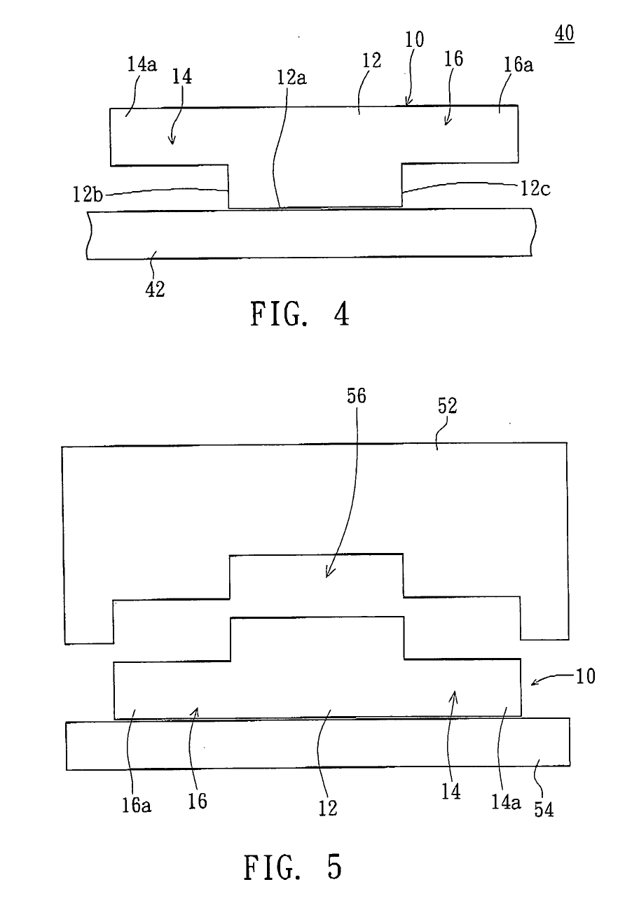

As shown in FIG. 4, the electrostatic discharge protection conductor 10 according to the invention may be disposed on the surface of a printed circuit board 42 within an electronic device 40. The solder's bottom surface 12a of the body portion 10 is disposed on the surface of the printed circuit board 42 via surface mount technology (SMT). The body portion 10 is electrically connected to the ground circuit of the printed circuit board 42 or to other ground conducting wires within the electronic device 40. When the electronic device 40 is stricken by static electricity, the first acute angle end 14a and the second acute angle end 16a will respectively introduces the electrostatic charges from outside the electrostatic discharge protection conductor 10 to the first protruding portion 14 and the second protruding portion 16 respectively. Meanwhile, the body 12 will deliver the introduced electrostatic charges from inside the electrostatic discharge protection conductor 10 to the ground circuit of the printed circuit board 42 or to other ground conducting wires within the electronic device 40 lest the static electricity might cause damage to the electronic device 40.

It is noteworthy that the structure of the electrostatic discharge protection conductor 10 is formed in one integral by using press mold method as shown in FIG. 5 where the invention uses a press head 52 and a press platform 54 to form the electrostatic discharge protection conductor 10. Of which, the press head 52 has a forming groove 56 whose shape of accommodation corresponds to the configuration of the electrostatic discharge protection conductor 10. The procedures involved in the press method of forming are disclosed below. First, place a material on the press platform 54. Next, use the press head 52 to press the material placed on the press platform 54 to form an initial configuration of the electrostatic discharge protection conductor 10. After that, place some more material for smoothing the initial configuration of the electrostatic discharge protection conductor 10. Last, a final configuration of the electrostatic discharge protection conductor 10 is completed.

Anyone who is skilled in the art will understand that the technology of the invention is not limited thereto. For example, the electrostatic discharge protection conductor 10 is metallic and may be made of copper alloy such as phosphor bronze or cupronickel. Moreover, the electronic device 40 may be a portable electronic device such a notebook, a personal digital assistant (PDA) or a mobile phone.

The electrostatic discharge protection conductor disclosed in the above preferred embodiment of the invention enhances the electrostatic discharge protection of an electronic device by introducing electrostatic charges from outside the electrostatic discharge protection conductor via an acute angel end of a protruding portion, then using a body portion to deliver the introduced electrostatic charges to a ground circuit of a printed circuit board or to other ground conducting wires within the electronic device.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An electrostatic discharge (ESD) protection conductor, which is disposed on a surface of a printed circuit board and electrically connected to a ground circuit of the printed circuit board, comprising:
a body portion, which has a solder's bottom surface and a first lateral surface, wherein the solder's bottom surface is soldered on the surface of the printed circuit board; and
a first protruding portion, which is electrically connected to the body portion and disposed on the first lateral surface, wherein the first protruding portion has a first acute angle end whose bottom surface has a first altitude difference with the solder's bottom surface.

2. The electrostatic discharge protection conductor according to claim 1, wherein the body portion further has a second lateral surface opposite to the first lateral surface, of which, the electrostatic discharge protection conductor further comprises:
a second protruding portion, which is electrically connected to the body portion and disposed on the second lateral surface, wherein the second protruding portion has a second acute angle end whose bottom surface has a second altitude difference with the solder's bottom surface.

3. The electrostatic discharge protection conductor according to claim 2, wherein the first altitude difference is substantially equal to the second altitude difference.

4. The electrostatic discharge protection conductor according to claim 2, wherein the top surface of the body portion, the top surface of the first protruding portion and the top surface of the second protruding portion are coplanar.

5. The electrostatic discharge protection conductor according to claim 1, wherein the electrostatic discharge protection conductor is metal.

6. The electrostatic discharge protection conductor according to claim 1, wherein the electrostatic discharge protection conductor is copper alloy.

7. The electrostatic discharge protection conductor according to claim 1, wherein the electrostatic discharge protection conductor is phosphor bronze.

8. The electrostatic discharge protection conductor according to claim 1, wherein the electrostatic discharge protection conductor is cupronickel.

9. The electrostatic discharge protection conductor according to claim 1, wherein the electrostatic discharge protection conductor is formed in one integral by using press mold method.

10. The electrostatic discharge protection conductor according to claim 1, wherein the electrostatic discharge protection conductor and the printed circuit board may be disposed in an electronic device.

11. An electronic device comprising at least:
a printed circuit board; and
an electrostatic discharge protection conductor, which is disposed on a surface of the printed circuit board and electrically connected to a ground circuit of the printed circuit board, comprising:
a body portion, which has a solder's bottom surface and a first lateral surface, wherein the solder's bottom surface is soldered on the surface of the printed circuit board; and
a first protruding portion, which is electrically connected to the body portion and disposed on the first lateral surface, wherein the first protruding portion has an first acute angle end whose bottom surface has a first altitude difference with the solder's bottom surface.

12. The electronic device according to claim 11, wherein the body portion further has a second lateral surface opposite to the first lateral surface, of which, the electronic device further comprises:
a second protruding portion, which is electrically connected to the body portion and disposed on the second lateral surface, wherein the second protruding portion has a second acute angle end whose bottom surface has a second altitude difference with the solder's bottom surface.

13. The electronic device according to claim 12, wherein the first altitude difference is substantially equal to the second altitude difference.

14. The electronic device according to claim 12, wherein the top surface of the body portion, the top surface of the first protruding portion and the top surface of the second protruding portion are coplanar.

15. The electronic device according to claim 11, wherein the electronic device is metal.

16. The electronic device according to claim 11, wherein the electronic device is copper alloy.

17. The electronic device according to claim 11, wherein the electronic device is phosphor bronze.

18. The electronic device according to claim 11, wherein the electronic device is cupronickel.

19. The electronic device according to claim 11, wherein the electrostatic discharge protection conductor is formed in one integral by using press mold method.

20. The electronic device according to claim 11, wherein the electronic device is a portable electronic device.
